(19) United States
(12) Patent Application Publication
(10) Pub. No.: US 2016/0042447 A1
(43) Pub. Date: Feb. 11, 2016

(54) Auction Website Interface

(71) Applicant: Nicholas N. Nassiri, Inglewood, CA (US)

(72) Inventor: Nicholas N. Nassiri, Inglewood, CA (US)

(21) Appl. No.: 14/820,441

(22) Filed: Aug. 6, 2015

Related U.S. Application Data
(60) Provisional application No. 62/033,988, filed on Aug. 6, 2014.

(51) Int. Cl. G06Q 30/08; G06Q 30/06

(52) U.S. Cl. CPC G06Q 30/08; G06Q 30/0641

(57) ABSTRACT

An auction system and software are provided for performing a live, real-time auction over the internet. The auction software includes a graphical user interface for an auctioneer to administer various functions of the auction. The auction software also includes a graphical user interface for a bidder to allow participation and bidding for various auction items.

### RELATED APPLICATIONS

This application claims priority to U.S. Provisional Application Ser. No. 62/033,988 filed Aug. 6, 2014 entitled Auction Website Interface, which is hereby incorporated herein by reference in its entirety.

### BACKGROUND OF THE INVENTION

It can be appreciated that various methods of auction have been in use for years. Prior to the advent of on-line or Internet auctions, traditional auctions conventionally took the form of a physical gathering of participants assembled together within a specified location; said location being where the goods to be auctioned physically resided. At such traditional auctions, a human auctioneer was the conductor of the auction and the individual responsible for shilling the goods to the auction participants. Incited by the direction of the human auctioneer, bidding was conducted simultaneously, successively and competitively among a group of participants present at the auction site.

As noted above, the presence, participation, and personality of the auctioneer was an essential component that provided the auction its sense of competitiveness and excitement. The auctioneer was responsible for instigating bids from auction participants and increasing the bid amount in succession by cajoling the auction participants, and closing the auction upon a cessation of bidding. Thus, in the traditional auction, the role of the auctioneer was not only essential to the functioning of the auction, but in generating the excitement and enjoyment of the auction participants.

The threat of immediate, rapid-fire, and constant competition from other participants was a key factor in the auction's thrill and in the ability of the auctioneer to drive up the current bid price. Thus, in the traditional form of auction, the threat of immediate, rapid-fire bid input, constant competition, the solicitation and offering of goods by an auctioneer, are essential.

The advent of electronic commerce, the Internet, and its related technologies, dramatically and profoundly changed the nature and the method of the traditional auction. The Internet and its related technologies have liberated the bidder from having to be being physically present at the auction. Likewise, the corollary is that the Internet and its related technologies permit the auction of goods from locations that are geographically remote from the bidders. To state the obvious: the Internet has been instrumental in forging a new electronic marketplace that allows sellers and bidders to unite without regard to the constraints of geographical boundaries.

### SUMMARY OF THE INVENTION

One aspect of the present invention includes a streaming bid display region which includes a generally rectangular graphical area that displays a unique bidder identification adjacent to an auction bid amount. The unique bidder identification is associated with a bidder and their user account. The streaming bid preferably displays the highest, current bid, along with several of the previous bids.

Another aspect of the present invention includes an auction floor interface 134 that provides a plurality of suggested bid graphical button elements that are associated with a dollar amount or with percentages lower than 100%. When the auctioneer presses one of these suggested bid buttons, a reduced suggested opening bid is transmitted out by the auction software to the webpage of online bidders for the auction. This allows the auctioneer to progressively reduce the suggested opening bid until the “bid floor” has been determined by the first, opening bid. This then changes the information on the auctioneer's pad as well as the information on the auction player where people are bidding in real time. After a predetermined number of suggested bid buttons have been pressed by the auctioneer or when a predetermined button has been pressed (e.g., the last or bottom suggested bid button), the auction software repopulates the buttons dynamically with new, lower percentage values, which thereby allow the auctioneer to further reduce the suggested opening bid value.

In another aspect of the present invention, an interface is provided to the auctioneer to contact the seller with one of several predetermined requests while an auction is being conducted. Specifically, the interface includes a button element to transmit a request to the seller to remove the reserve from an auction item, reduce the reserve by a determined amount, and accept a highest bid that is under the reserve. The seller can also respond with a yes or no to any questions that might be posed online.

In another aspect of the present invention, a bidder interface is provided, having a brand logo area or webpage background that is predetermined and can be uploaded by a seller of an auction item. In this respect, the seller can customize a bidder's interface with brand logos and/or other custom designs while a particular auction item is being auctioned.

Another aspect of the present invention provides a custom bid interface that generates a window displaying a text box or a selection slider that allows input of a specific bid amount. The auction software will round the entered number to the nearest bid increment previously determined by the auctioneer. For example, if the Auctioneer previously determined that all bid increments will be in $100 or 10% increments, the custom bid will be rounded up or down to the nearest $100 or 10% increment. Additionally, the custom bid interface provides a plurality of button elements with predetermined percentages greater than 100%. When selected, these button elements submit a bid amount that increases the current asking bid increase by the button's shown multiplier or percentage. For example, if the auctioneer asks for a bid of $10 higher than the current highest bid level, the 2× or 200% button element submits a bid of $20 (i.e., $10 multiplied by 200%). Hence, a bidder can quickly make a larger bid, if desired. This aspect also has other buttons, such as 3× or 300%, or 5× and 500%, allowing for more rapid advancement of the bidding.

Another aspect of the present invention includes an auctioneer selection interface that provides a profile, as well as a sample video of an auctioneer, their expertise and other professional details, and a selection element for requesting that this auctioneer perform the auction for a specific auction item. The auction software notes this request and groups and/or schedules an auctioneer accordingly.

### BRIEF DESCRIPTION OF THE DRAWINGS

These and other aspects, features and advantages of which embodiments of the invention are capable of will be apparent and elucidated from the following description of embodiments of the present invention, reference being made to the accompanying drawings, in which

FIG. 1 illustrates an auction system for performing a live, online auction with an auctioneer and one or more bid;

FIGS. 2A and 2B illustrate a graphical user interface for an auctioneer to administer an auction;

FIGS. 3A-3D illustrate a graphical user interface for a seller to respond to request from an auctioneer during an auction;

FIGS. 4A-4B illustrate a graphical user interface for a bidder to participate in an online auction;

FIG. 5 illustrates a graphical user interface allowing a bidder to bid in larger increments to jump the bid ahead;

FIG. 6 illustrates the bid now button stages for the bidders interface;

FIGS. 7A-7B illustrate the bid matrix and how the bidding increments are arrived at;

FIG. 8 Illustrates the change reserve popup from the seller controls.

FIG. 9 illustrates another embodiment of a graphical user interface for a bidder to participate in an online auction.

### DESCRIPTION OF EMBODIMENTS

Specific embodiments of the invention will now be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the invention. In the drawings, like numbers refer to like elements.

Some background and other details with regard to the present invention may be found in U.S. Pat. No. 8,036,949, the contents of which are hereby incorporated by reference herein. Various different terminologies are used in this specification which relates to graphical user interface elements, such as buttons, elements, regions, areas, media, and windows. It should be understood that these and other terminology refer to graphics that are displayable on a display screen and that can be interacted with (e.g., via touch screen, mouse and/or keyboard) or be associated with other graphical elements that can be interacted with by a user. It should also be understood that the auction software may be located and executed on the storage device/medium of a single server or may have separate portions distributed on various servers that interact with each other. Further, the terms servers, computers, PCs, tablets, or similar computing devices are all considered to at least have processors for executing software stored in memory, communications components (e.g., Ethernet or wifi) for communicating with other devices across a data network, as well as input devices, such as touch screens, mice, or keyboards, to interact with the software. The software may at least include an operating system, a web browser, auction software.

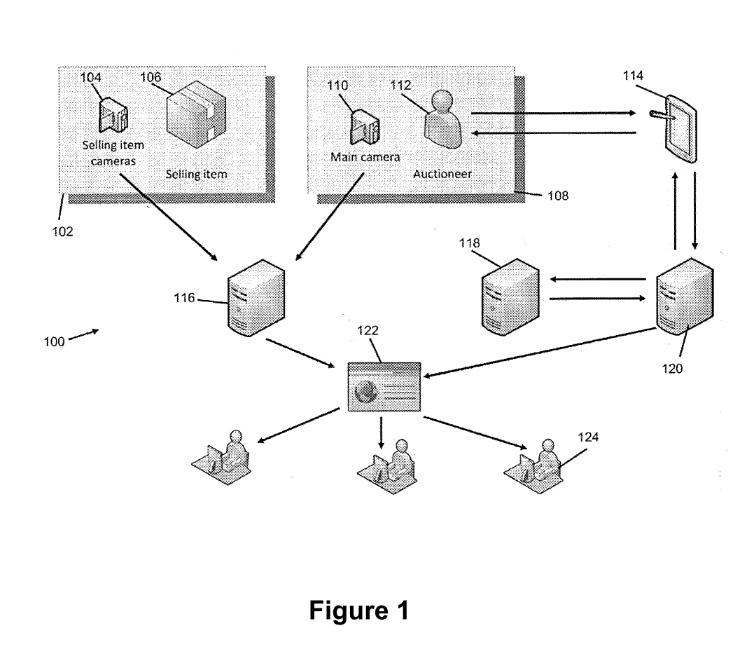

FIG. 1 illustrates an online, real-time auction system 100 according to the present invention. Generally, the auction system 100 allows a human auctioneer 112 to conduct a real-time auction (i.e., an auction that typically spans several minutes with all bidders maintaining their attention on the auction instead of several days in which bidders may only occasionally view the status of the auction) with a plurality of remote bidders 124. In other words, the auction is generally performed when several bidders 124 are viewing a bidder interface for an auction item 106 at the same time.

Preferably, the auction system 100 includes a media server 116, a database server 118, and a web server 120, which may be separate servers, may be virtualized on one or more physical servers, or may all be performed by a single server. The media server 116 preferably accepts images, video and/or audio from a first location 102 via camera 104 of auction item 106. For example, a seller may take a picture of an auction item 160, log on to a seller interface on webpage 122, and cause the auction item's image to be stored in a memory on media server 116. The media server 116 also accepts images, video, and/or audio of the auctioneer 112 via camera 110, occurring at the same location 102 as the item 106 or a different location 108. For example, the main camera 110 may record video of the auctioneer 112 to the server 116 during an auction, which is then displayable in webpage 122 when viewed by a bidder 124.

The auction software on the web server 120 serves up web pages to the auctioneer 112 (as a control interface for controlling the progression of the auction) and to the registered auction bidders 124 for interacting with one or more auctions. The web server 120 also accesses and stores auction data on data server 118 (e.g., bid data, user names, passwords, account information, auction item data, etc.). The auction web page 122 is generally served by the web server 120. Images, video, and audio from the media server 116 are preferably downloaded or streamed by the bidders 124 directly via the code of the web page 122 (e.g., the downloaded webpage provides embedded media from the media server's address).

The auctioneer 112 preferably conducts the auction via a computing device such as tablet 114, which sends and receives data with web server 120. Preferably, the computing devices used by the auctioneer, bidders, and sellers all include a processor that can execute code or other instructions, communicate over a LAN/WAN, a display that can display a graphical user interface, and at least one input device, such as a touch screen, mouse, or keyboard. Each of these computing devices can utilize a web browser to view the auction software's graphical user interfaces or can utilize a stand-alone application.

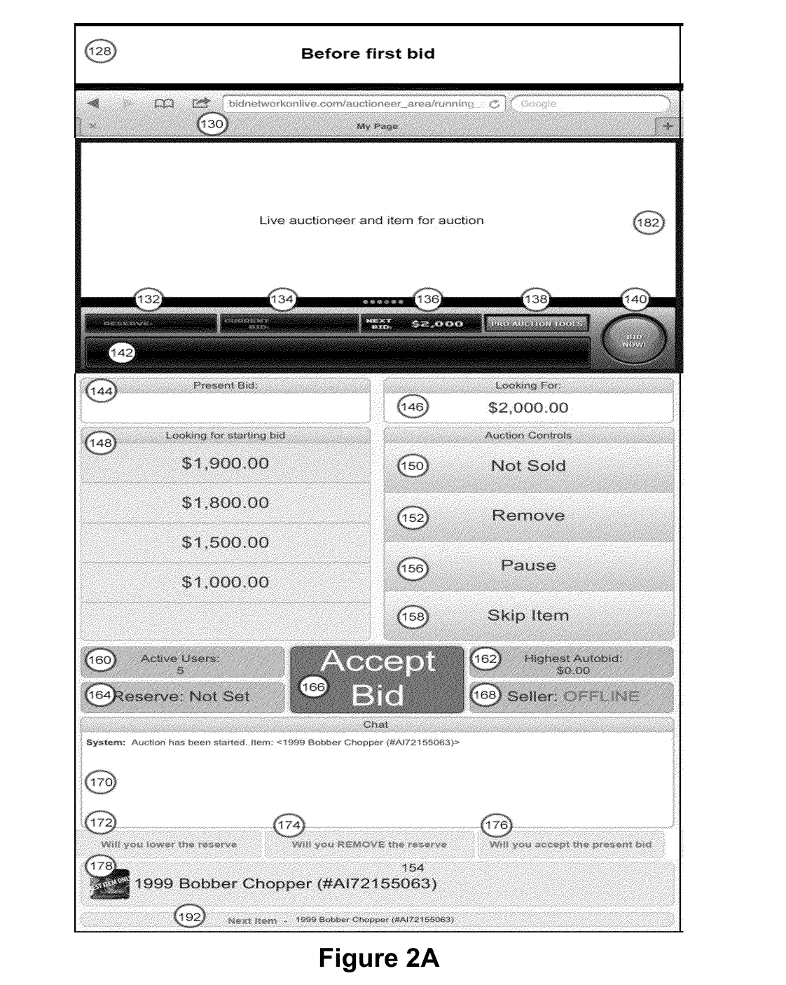

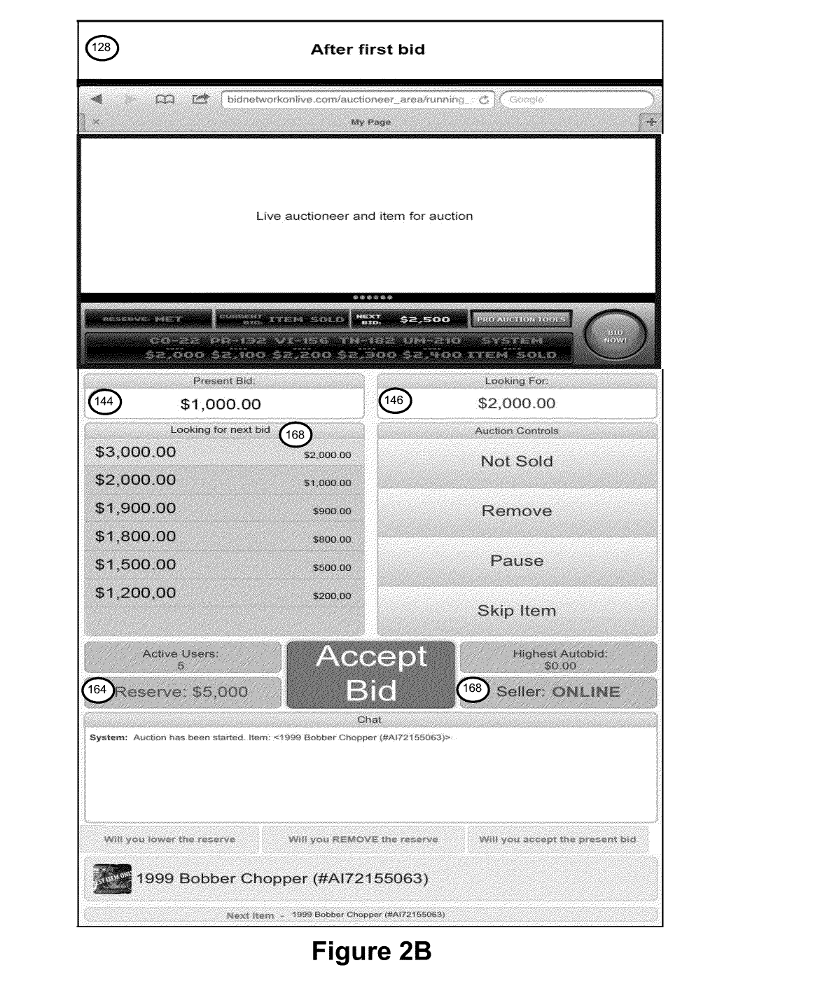

An example auctioneer interface 128 is shown before a first bid has been entered (FIG. 2A) and occurring after a first bid has been entered (FIG. 2B). The interface 128 is preferably displayed in a web browser or a standalone application and used by the auctioneer 112 to administer the auction. The auctioneer interface 128, includes a media region 182 that can display images, video, and/or audio relating to the auction item (e.g., from media server 116). The media region 182 may also optionally display images, video, and/or audio of the auctioneer 112. It should be noted that while the first auctioneer interface 128 may be primarily discussed.

The auctioneer interface 128 also includes a streaming bid display region 142, which provides a unique bidder identification (associated with a bidder's user account), such as a bidder ID number or username, that is positioned adjacent to a bid level for an auction item. For example, the bid level may be located above, below or to the side of the auction item identification. Preferably, the current, highest bid level and the associated bidder ID is displayed in this region 142, along with several of the previous bids. This allows the remote auctioneer 112 to call out or thank the highest bidder by name, sudo name, ID number, and/or geographic location (e.g., “Thank you California 602). The information in the streaming bid display region 142 may move sideways (e.g., left to right), may remain stationary, and/or may move only during the addition of new information (e.g., addition of a new, highest bid). In this respect, the auctioneer can easily view the current bid level for an auction item, as well as several previous bid levels.

A description of the current auction item is displayed in the auction description area 178, which is preferably located below a streaming bid display region 142, or alternatively at the bottom of the page. The description within this area is preferably a text description that has been previously entered by the auctioneer or seller creating the auction and is stored in the memory of the database server 118.

The auctioneer interface 128 also includes an auction preview region 192 that is preferably located along a bottom of the interface 128. The auction preview region 192 preferably provides the auctioneer with information relating to upcoming auctions, such as an auction item image and text description.

Additionally, “next bid” region 148 preferably includes a set of starting bid button elements that, when pressed, allows the auctioneer to enter a starting or asking bid for that upcoming auction 146. Specifically, selecting one of the bid button elements causes the auctioneer's tablet 114 (or similar computing device) to transmit the monetary starting/asking bid for the auction item to the web server 120, then on to be stored in the memory of the database server 118. The webserver 120 then relays this opening or asking bid out to the auction web page 122 being viewed by logged in bidders 124.

Once a bid button element, and therefore a bid, has been selected from region 148, the same region can also be used by the auctioneer 112 to modify a previously entered starting or asking bid for the upcoming auction by pressing a lower amount shown on the button. The buttons can dynamically update to a lower amount as the potential starting bid is selected each time. For example, the top button of region 148 may change its displayed bid value to that of the button immediately below it. This pattern would continue until the bottom button, which would then display a bid value that is lower than the button above it by a predetermined amount. This would then be reflected in the “looking for” section 146 on the auction pad as well as update to the main auction screen that the bidders see (i.e., sending the updated bid values back to the servers, then distributed to the webpages of the bidders).

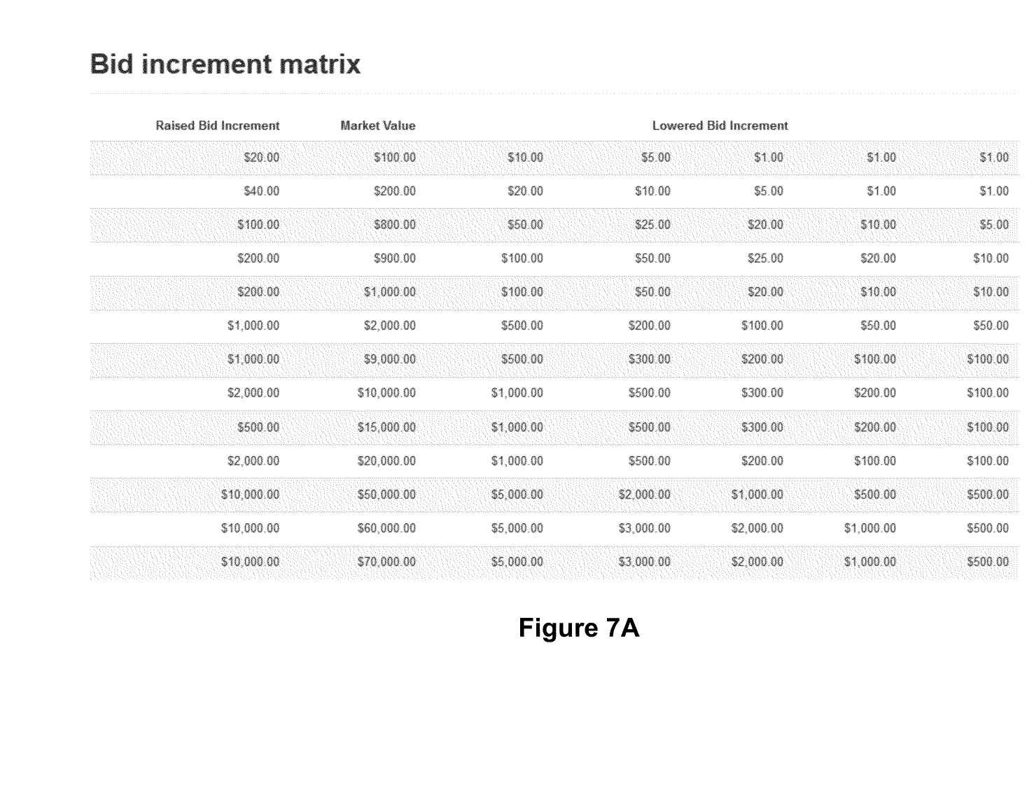

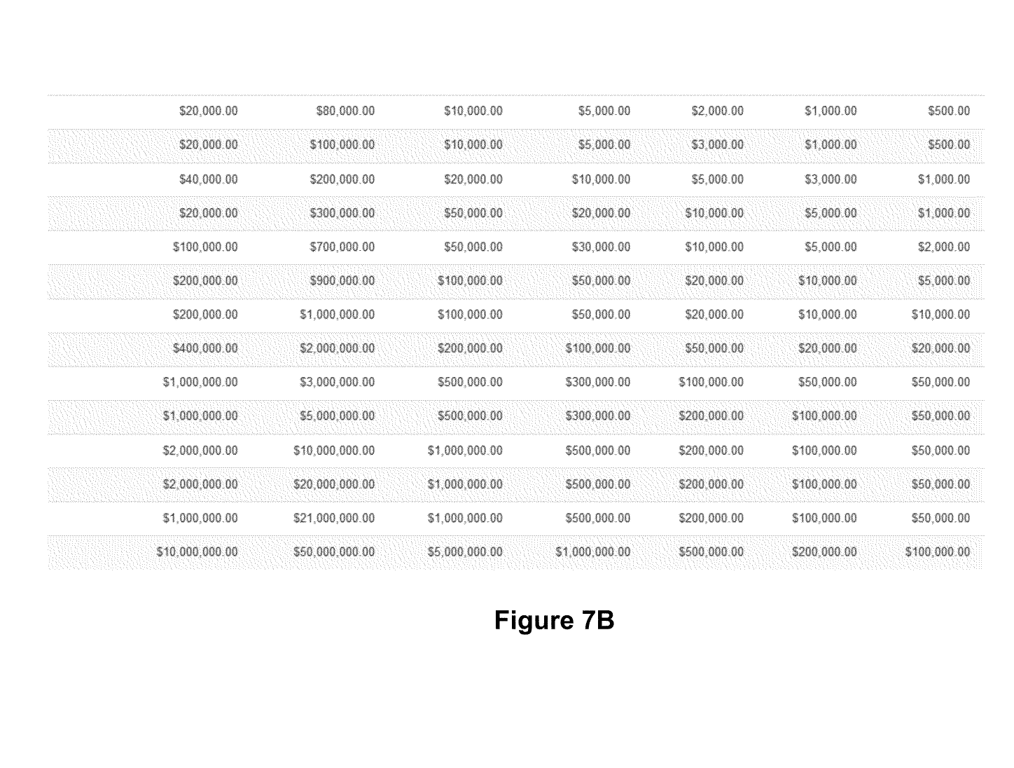

In one embodiment, the increments on the “next bid” region 148 are entered into or computer generated into a bid matrix, which allows the ability to keep the numbers rounded and appropriate for each auction. One example bid matrix can be seen in FIG. 7A and continued in FIG. 7B and can be a numerical table or database that acts as a central location for lowered bid increments. Specifically, the bid matrix table is initially created or stored in the memory of the database server 118 and populated with desired values. For a specific “Market Value”, the “Lowered Bid Increment” columns provide the amount the “next bid” region 148 may display on their buttons. In one example, an auctioneer can call a bid online of $1000, and then lower it to $900, but, unless that bid is also assigned into the bidding software, the bidders will have no way to bid that. The bid matrix preferably consists of numbers starting at $1 and ranging to more than $100,000,000, broken into stages, such as $1000 to $1999, $2000 to $8999, etc. Each of these ranges have an incremental bid breakdown, as in $1000 to $2000, would have bid increments of $500, $200, $100, $50, These bid increments and ranges can be raised, lowered or otherwise assigned by the auctioneer or another auction administrator prior to the auction (e.g., bids for items selling for $5,000-$10,000 will have increments of $500, while bids for items selling for $20,000-$30,000 will have increments of $1000).

In a typical auction, the auctioneer may start bidding off at a relatively high value and then supply progressively lower suggested bid values until a bidder makes or accepts a suggested bid. This process is sometimes known as determining the “floor” or lowest bid level for auction bidding to start at. Region 128 allows the auctioneer 112 to more easily determine this bid floor. As previously discussed, FIG. 2A illustrates the “next bid” region 148, which displays on the Auctioneer interface 128 (though this interface may initially be displayed on its own at the beginning of an auction). The interface 148 preferably includes a plurality of suggested bid button elements that, when selected, determine a reduction in the asking bid amount which is then transmitted to the interfaces of each of the bidders. Preferably, the elements 148 are labeled with currency amounts or percentages, each of which is progressively lower than the element above it (e.g., each element 148 is below 100% and decreases in either a currency or percentage (%) increments). When clicked or selected, the buttons in region 148 cause the auction software to reduce the opening asking bid by its displayed amount or percentage (i.e., a lower opening bid or asking bid is transmitted out to and displayed on the bidder's webpage 122). For example, a “90%” element 148 reduces a $100 suggested bid to $90. When the auctioneer 112 clicks or selects either a certain number of button elements from region 148 (e.g., four element 148) or a certain button towards the bottom of the interface (e.g., the fourth element 148 down), the interface 148 dynamically repopulates the elements 148 with progressively lower currency or percentage values (as previously discussed), thereby allowing the auctioneer 112 to further reduce the suggested bid level (shown in the “Looking for” area 146), if necessary.

Once a first bid from a bidder 124 is submitted, the auctioneer interface 128 automatically displays the current, highest bid in the streaming bid display region 134, as seen in FIG. 2B. As new higher bids are received, the streaming bid display region 143 maintains a list of several of the most recent bids, with the highest and currently winning bid sorted and/or highlighted at either the left or right of the streaming display. Preferably, each bid in the list is accompanied by the respective bidder ID of the bidder 124 that made the bid (i.e., a unique identifier associated with a bidder's account). In this respect, the auctioneer 112 can view the display region 142 during an auction and appropriately monitor the highest bid.

The auctioneer interface 128 also includes an action interface selection area which provides several different interface elements that allow the auctioneer 112 to control various other aspects of the auction. For example, the selection area may include an Accept Bid button 166 that when selected, causes the auction software to accept the current highest bid and end the auction, thereby awarding the auction item to the highest bidder.

In another example, the selection area may include a contact seller button element 172, 174, and 176, for allowing the auctioneer 112 to contact the seller during an auction. If any of these button elements 172, 174, and 176, are selected by the auctioneer 112 when the current auction bid in area 144 is lower than the auction item's reserve price 132, a message is sent to the seller and is displayed in the display area 170. Specifically, the remove reserve button element 174 sends a message to the seller requesting that the auction's reserve be removed, a reduce reserve button element 172 and/or an accept highest bid button element 174/176 for requesting that the highest current bid be accepted to end the auction. The display area 170 also shows an audit trail of questions asked and answered by the seller and auctioneer. Offering truly interactive communication with the seller and the auctioneer live during the auction.

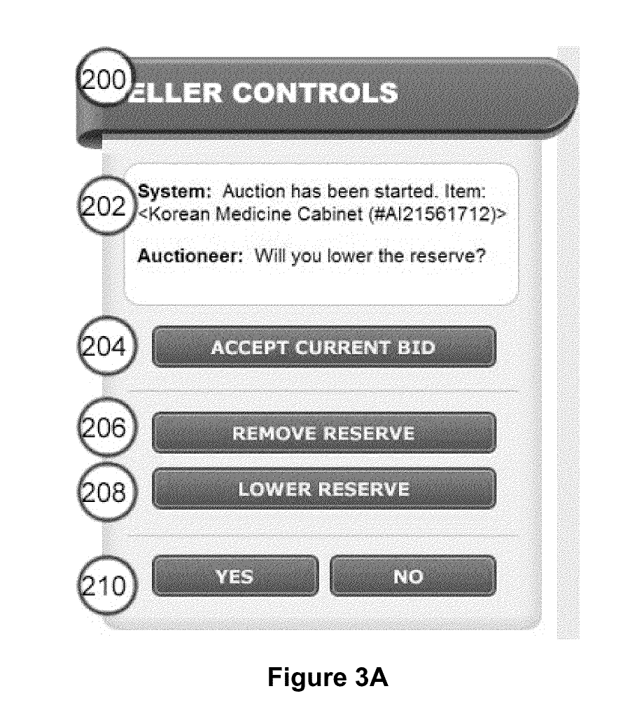

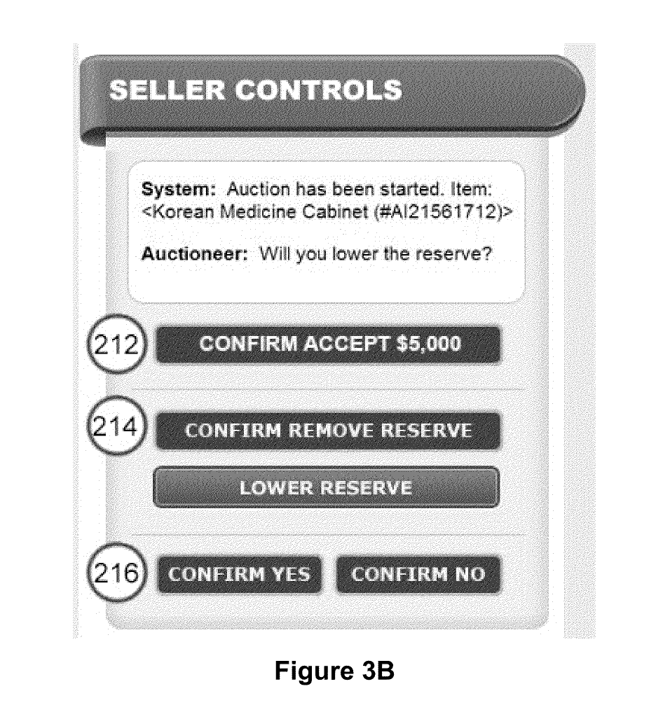

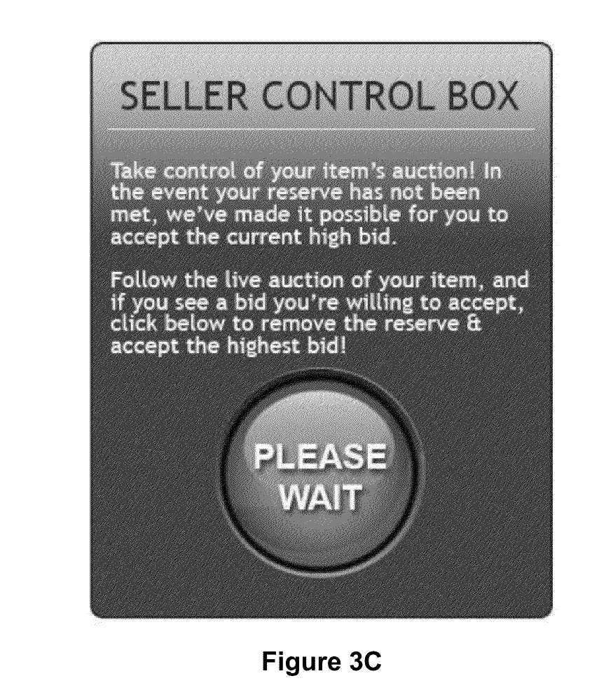

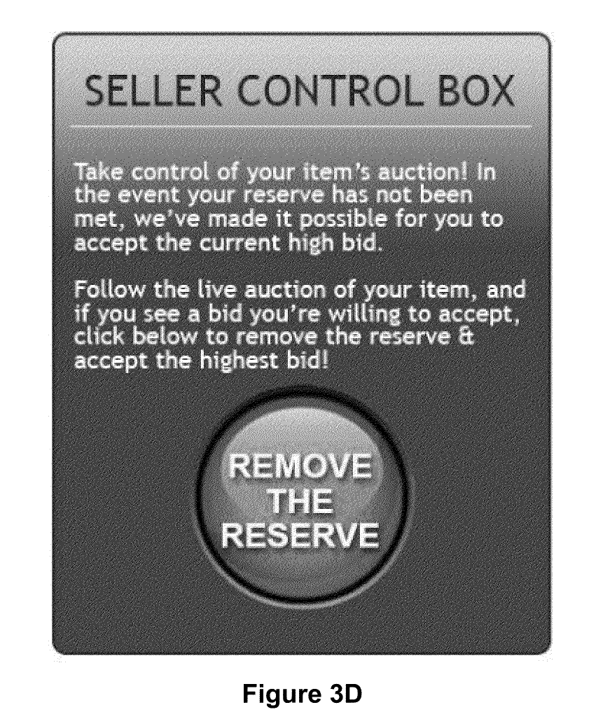

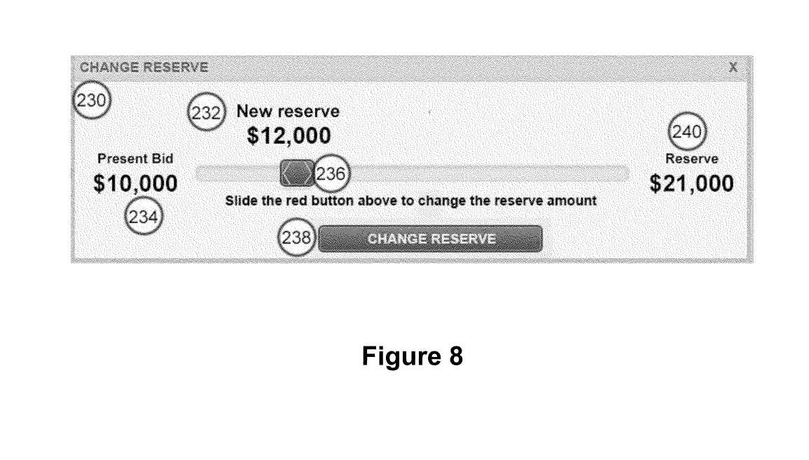

Once one of these button elements 172, 174, and 176 are clicked or selected, the web server 120 contacts the seller (if they are not already on the auction's website 122), and provides them a link (e.g., via email, SMS, or popup notification from the website 122) to a seller auction interface 200, shown in FIGS. 3A and 3B. The seller auction interface 200 provides an information display element 202 that displays the auctioneer's request to the seller and a method of responding to the message (e.g., one of the button elements 172, 174, and 176). The seller can respond to the bidder's request by clicking or selecting one of several responses, such as a remove reserve button element 206 to remove the auction's reserve, a reduce reserve button element 208 and the accompanying pop up currency slider interface 230 in FIG. 8 to reduce the reserve to a specific level, and an accept highest bid button element 204 to accept the highest current bid, even if it is below the current reserve of the auction item. A yes or no button 210 to respond to any miscellaneous questions from the auctioneer 112. The alert area 202 shows any questions the auctioneer has asked from button elements 172, 174, and 176, as well as any of the seller's responses. Upon pressing of the button, there will be a confirmation button, preferably in green, 212, 214, and 216, to confirm and reduce the amount of bidding mistakes.

An alternate, simplified seller auction interface is shown in FIGS. 3C and 3D. In FIG. 3C, a single button is visible to the user, displaying the phrase “please wait” and which cannot be selected by the user. In the event that, during the auction for a seller's auction item, the current bid value has not met the reserve, the button displays the message “Remove the Reserve”, allowing the user to select the button to remove the reserve on the auction item.

The lower reserve button 208 in the seller controls 200 is shown in FIG. 8. A currency slider element 230 allows the seller to rapidly change the reserve price. The change reserve window shows the present bid 234, the present reserve that is set 240, and a slider 236 that they can move horizontally left or right to lower or raise the amount of the reserve. The new reserve amount 232 will be shown at the top of the sliding button 236 and will update dynamically as they slide the button 236. To accept the new amount and set it, they will click the accept button 238 and as an added feature, the button will change state to green and ask them to accept again, to confirm the change in reserve. The amounts in the slider 236 are dynamically rounded and further updated in appropriate bid increments from the bid matrix FIG. 8.

Returning to the auction interface selection area 142 in FIG. 2A and 2B, a not sold button element 150 advances the auctioneer interface 128, to the next item in line for auction. The Remove 152 button element will remove the item from the present auction and continue on to the next item. The pause 156 button element will pause the auction not allowing any bids until un-paused. The skip item 158 button element will skip the item and move to the next item in the list but append the skipped item to the end of the auction to be bid on again. As should be clear, interfacing with each of these buttons executes a command that transmits data to the servers 112, 116, 118, causing the servers to store the command in memory, then execute the specific command.

In addition, the auctioneer interface 128 on the auction tablet 114 includes several other interface items. For example, an active user display that illustrates how many active users are participating in the auction at any moment 160. In another example, the auctioneer interface 128 includes a reserve status display 164 that alerts the auctioneer as to whether the reserve has been met, or not, and what monetary value the reserve is. In another example, the auctioneer interface 128 includes a highest autobid display 162, which displays what the highest monetary value that a bidder has set the autobid feature to (i.e., a feature that will place a bid to outbid a competitive bidder, up to a set threshold). In yet another example, the auctioneer interface 128 includes a seller connectivity display 168 that indicates whether the seller is logged into the website 122 served up by the webserver 120.

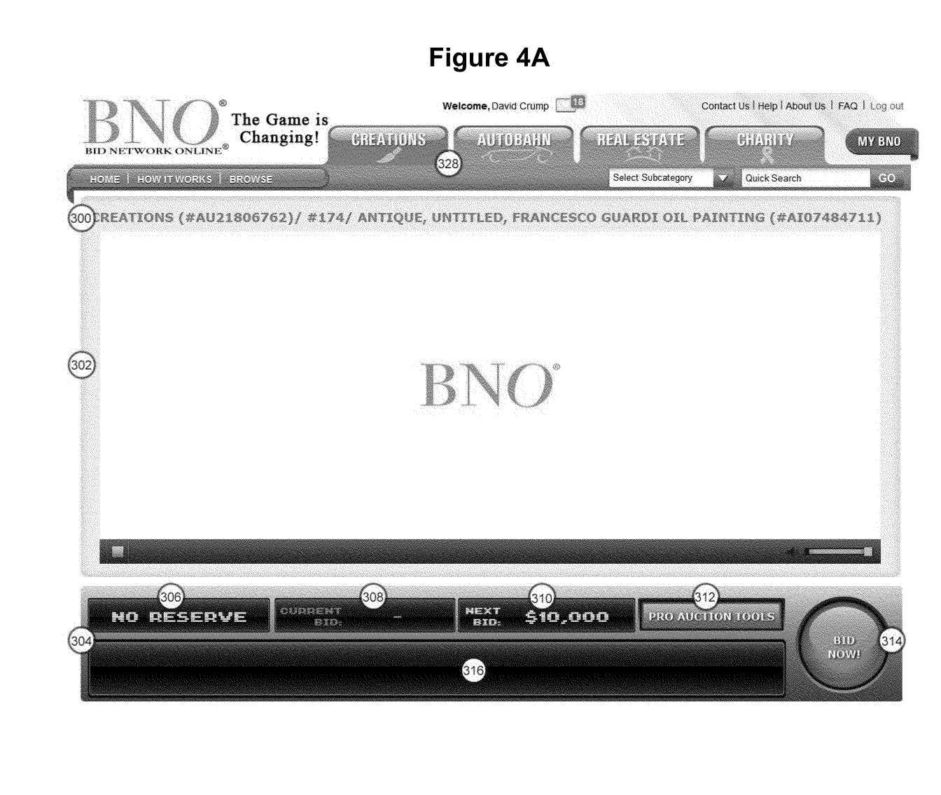

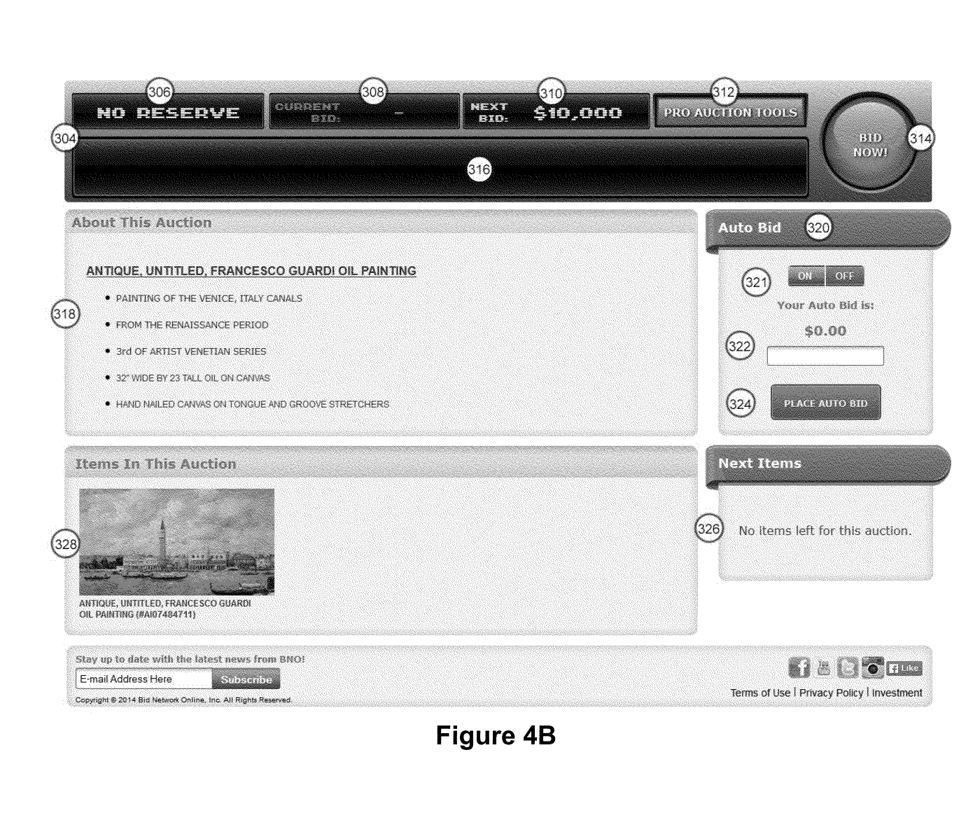

A top portion (FIG. 4A) and a bottom portion (FIG. 4B) of a bidder interface 300 is shown for display in a web browser or a standalone application. The bidder interface 300 includes many of the same or similar interfaces as described for the auctioneer interface 128, such as the media region 302 that displays the pictures or video of the auctioneer 112 and/or the selling item 106 from the media server 116, the streaming bid region 316 that displays real-time bids during the auction, and the auction preview region 326 that illustrates the next selling item in the auction to be bid on. In one aspect of the streaming bid region 316, when a bid is accepted, the ID number of the bidder is highlighted in a bright color to acknowledge the bidder's bid. Additionally, the bidder interface includes an auction item summary 318, which includes important information about the current auction item, such as the item type, item condition, item date, auction ID, and event item ID.

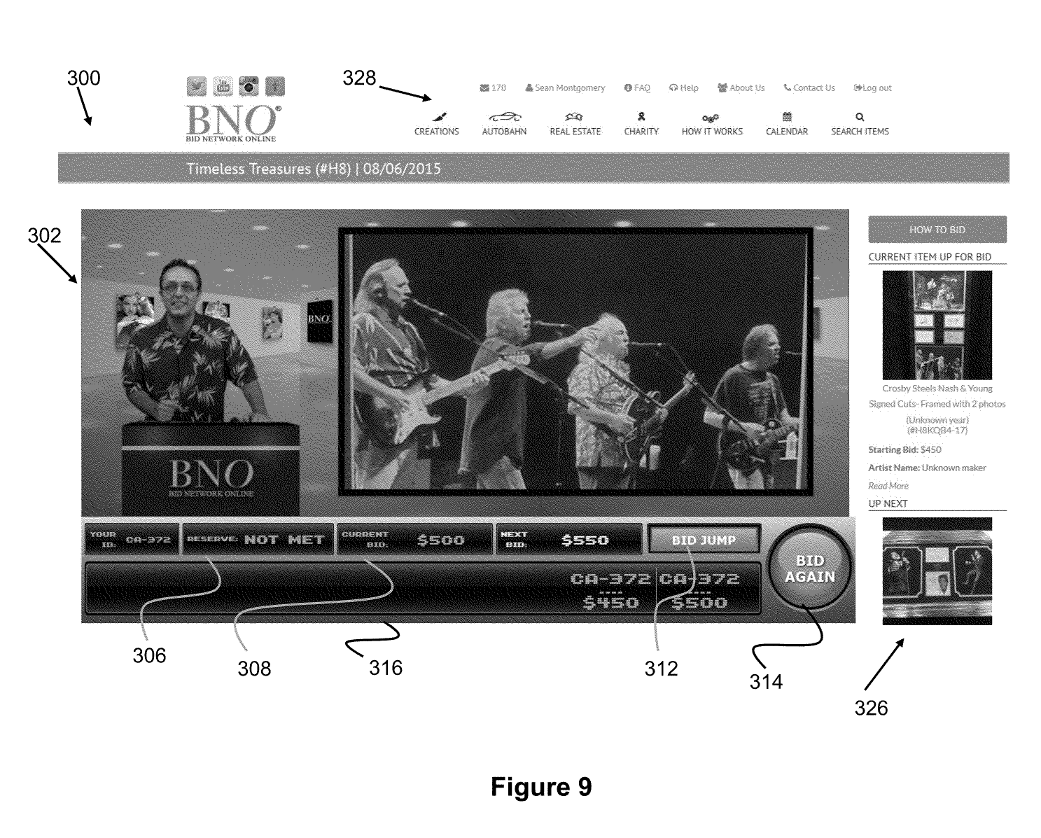

FIG. 9 illustrates an active bidder interface 300 during an in progress auction. The auctioneer 112 can be seen in the media region 302, the streaming bid region 316 includes a high bid, and the bid reserve display 306 indicates that the reserve has not yet been met.

Typically, a single auction event may auction several different items (e.g., several different types of cars). The auction item area 328 displays one or more of the other items, in addition to the currently auctioned item, that are also being auctioned as part of the current auction event. In this respect, the bidder 124 may be alerted to other auction items that may have some similarity to the present auction item.

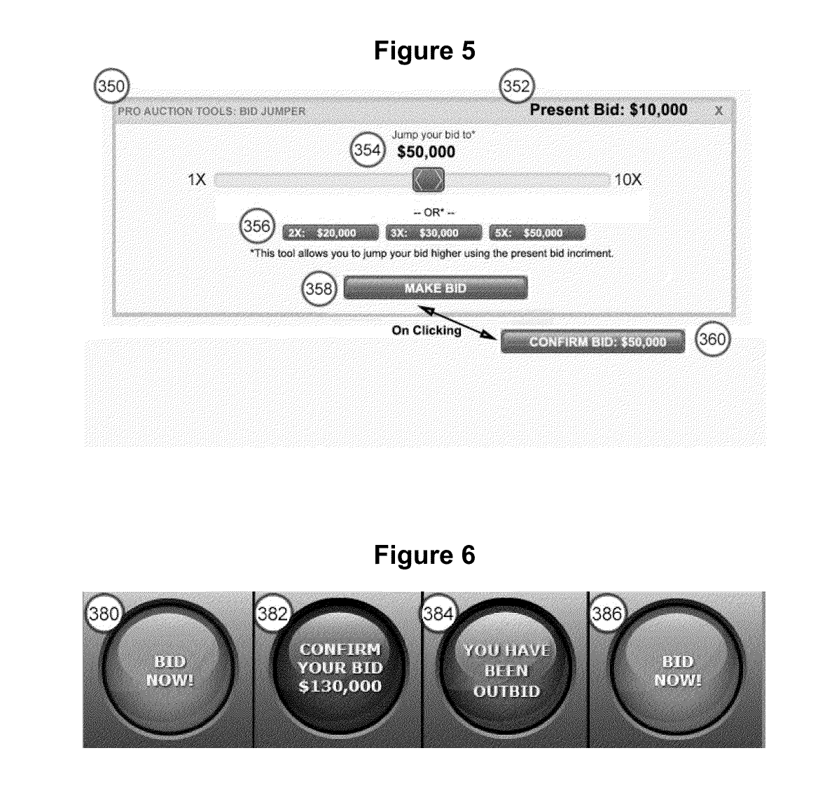

Bidder action area 304 provides two main action button elements for the bidder to use during an auction: a make bid button element 314 and a custom bid button element 312. By selecting or clicking the make bid button element 314, the bidder accepts the next or asking bid (e.g., as shown in the streaming bid region 316). However, if the bidder wishes to make a bid that is different from the next bid, the custom bid button element 312 can be selected. This element 312 displays a window with a custom bid entry interface, as seen in FIG. 5. In the top region of the pop up window 350, a present bid display 352 displays the monetary value of the current bid in the auction.

A slider interface element 354 is also shown. Moving the slider interface element 354 to the left decreases the bid amount displayed over the slider, while moving the slider to the right increases the amount of the bid. In one example, moving the slider all the way to the left decreases the bid value to (1×) 100% of the present bid increment the value of the current asking bid, moving the slider to the right increases the bid value to (10×) 1000% of the current asking bid, and positions in between adjust the bid to a value between 1× and 100×, relative to the slider's position.

The custom bid entry interface 350 also includes a bottom region having three quick bid selection buttons 356, which allow the bidder to set a bid at generally 2 times, 3 times, or 5 times the current bid increment without using the slider element 354. Specifically, the auction software accesses the bid increment matrix shown in FIGS. 7A and 7B to determine what the next “raised bid increment” is, then determines the bid value displayed on the left, middle, and right buttons as twice, three times, and five times the raised bid increment from the matrix, respectively. Once the bid is selected, either with the slider element 354 or the quick bid selection buttons 356, selecting the make bid button 358 displays a confirm bid button 360, which, when selected confirms the chosen bid amount.

Returning to FIGS. 4A and 4B, the bidder interface 300 preferably includes a plurality of navigation tabs 328 with general auction item categories. Selecting one of these tabs presents the user with a list of upcoming auction items in that particular category.

The bidder interface of FIGS. 4A and 4B can also be customized or branded by a seller for a particular auction item. For example, a seller's interface can allow the seller to upload one or more images of a brand logo in connection with an auction item. This logo or image can be displayed in various locations, such as the background of the bidder interface 302.

The bidder interface 300 also preferably includes an indicator 306 that indicates if the reserve of an auction item has been met. For example, the indicator may state “reserve not met” or “reserve met” as appropriate during an auction. In some cases, a seller may wish to disclose the reserve price, which would be displayed in the indicator 306. For example, the indicator 306 may state “reserve of $100 not met.”

In another example, the reserve level may not be explicitly disclosed, but may instead be estimated for a bidder by color. For example, when a highest bid is low and therefore far from a reserve price, the indicator 306 may be red. As the highest bid level increases towards the reserve level (e.g., within 10% of the reserve level), it may turn orange and then, finally green when the reserve has been met.

Another aspect of the bidder interface 300 of FIGS. 4A and 4B is the large bid now button 314. This button 314 will change the text it displays, as well as its color, to show if the bid has been accepted, or outbid, as seen in FIG. 6. When the system is waiting for a bid the button is colored red and displays the text “Bid Now!” as seen in item 380. If the bidder selects the button 314 to bid, the button will turn green and display a message asking to confirm the specified bid amount, as seen in item 382, and thereby requiring a second selection of the button 314 to register the bid in the auction, thus creating a 2-click system for confirmation and less accidental bidding. If the bidder has been outbid, the button 314 will turn yellow, and display the text “You Have Been Outbid” as seen in item 384. Finally, if the bidder's bid was accepted and is the highest bid, the button 314 will turn grey and will prevent further selection until or unless a higher bid by another bidder is accepted by the auction software, as seen in item 386.

In one aspect of the present invention, an auctioneer selection interface is provided to a seller as part of setting up the auction of their item. The interface provides an auctioneer selection area with a description and selection link for one or more auctioneers. For example, the area includes media of an auctioneer (e.g., an image, video, or audio of an auctioneer performing an example auction), the auctioneer's name, the auctioneer's expertise, a link for a detailed auctioneer biography, and a link or button to select a specific auctioneer to auction the seller's item. In this respect, the seller can have more control over how their item is auctioned.

In another aspect of the present invention, the bidder interface 300 in FIGS. 4A and 4B provides an absentee bidding input interface 320 that, when turned on via interface 321, allows a potential bidder to input an absentee bid level into input box 322. Once submitted by selecting the “place auto bid” button 324, the auction software incrementally submits bids in minimal amounts during an auction up until the bidder wins the auction or until the absentee bid level is met. If an auction has automatic absentee bidders, the software will automatically start bidding at the reserve amount (assuming the absentee bid level has been set above the reserve price) and then proceed with automatically and incrementally submitting bids at predetermined intervals (e.g., every 5 or 10 seconds) and at minimal bid increments determined by the auctioneer's asking bid. This interval allows the auctioneer time to solicit bids from live bidders 124. Preferably, if an absentee bidder logs into the auction software via webpage 122, the bidder will be presented with an interface display that notifies the bidder that the auction is currently underway. The bidder is provided an option via button 324 to manually override automatic bidding by the auction software. The bidder can also turn the absentee bid on or off at any time via button 321.

In one aspect of the present invention, the bidders 124 and auctioneer 112 can all be located at a single, physical location and can each access the variously described interfaces via mobile tablets, phones, or laptops. In this respect, various events, such as charity events, can have a live, in person auction that proceeds similar to a traditional, in person auction but that utilizes the previously described auction software for administering the auction, bidding and performing other auction functions. This aspect includes the method of conducting an auction at a first location with a first graphical user interface that is in communication with a remote server (element 250) and accepting bids from bidders located at said first location via a second graphical user interface in communication with said remote server.

In another aspect of the present invention, the previously described auction software can be used in connection with other media, such as TV or radio. For example, a TV personality on a TV program may act as the auctioneer 112 and conduct the auction while viewers log onto the auction webpage 122 and bid on the auction.

It should be understood that the terms clicked or selected have been used in connection with various graphical elements of the auction interface, but can also mean touched, engaged, activated, or otherwise actively chosen by a user. This selection may be via a hand for touch interfaces or via a mouse/keyboard for non-touch interfaces. In one aspect of the present invention, inputs of the various interfaces can be performed via speech recognition, allowing auctioneers and bidders to rely on voice commands to navigate and interact with the previously described interfaces.

It should also be understood that the present invention includes methods of performing an auction that include displaying and interfacing with any of the previously described interfaces and/or interface elements.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A computer readable storage medium storing one or more programs, the one or more programs comprising instructions that, when rendered on a remote computing device, cause the device to:
display a graphical user interface having a plurality of graphical elements that each control administration of a live, online auction.

2. A graphical user interface on a computing device having a display and an input, the graphical user interface comprising:
a plurality of graphical elements that control bidding during a live, online auction.

3. A method of performing an auction, comprising:
conducting an auction at a first location with a first graphical user interface that is in communication with a remote server;
accepting bids from bidders located at said first location via a second graphical user interface in communication with said remote server.
